(19) United States
(12) Patent Application Publication
(10) Pub. No.: US 2025/0296096 A1
(43) Pub. Date: Sep. 25, 2025

(54) VOICE-CONTROLLED SHOWERHEAD

(71) Applicant: Sasha Ovalle, Los Angeles, CA (US)

(72) Inventor: Sasha Ovalle, Los Angeles, CA (US)

(21) Appl. No.: 19/085,365

(22) Filed: Mar. 20, 2025

Related U.S. Application Data
(60) Provisional application No. 63/568,981, filed on Mar. 22, 2024.

(51) Int. Cl. B05B 1/30; B05B 1/18; B05B 12/00

(52) U.S. Cl. CPC B05B 1/3026; B05B 1/18; B05B 12/00

(57) ABSTRACT

A voice-controlled smart showerhead is disclosed which enables a person to turn water flow on and off using voice commands. The voice-controlled smart showerhead includes a showerhead housing, a battery compartment, and an embedded internet/Wi-Fi switch with built-in Wi-Fi and/or Bluetooth connectivity which provides a way to connect to a smart home device/speaker, such as Amazon Echo or Google Home, that captures, analyzes, and relays audible showerhead control commands.

### CROSS REFERENCE PARAGRAPH

This U.S. Non-Provisional Patent Application claims the benefit of and priority to U.S. Provisional Patent Application No. 63/568,981, filed on Mar. 22, 2024, by inventor Sasha Ovalle, the contents of which are expressly incorporated herein by this reference.

### FIELD OF USE

The present disclosure relates, in general, to a device for controlling water flow. More specifically, the present disclosure relates to a device for controlling water flow through a showerhead via voice controls.

### BACKGROUND

Currently, the existing showerheads waste a substantial amount of water due to the inconvenience of their manual control hardware (e.g., a shower “knob” or “knobs”) for turning the water flow on and off. Most conventional showerheads are connected by plumbing to separate manual control hardware mounted and protruding out of a shower wall. While there are some showerheads with their own integrated controls, these are limited to physical contact controls or motion sensors.

The problem of water waste occurs during everyday showering when people find it difficult or inconvenient to manually turn off water flow during moments in a shower when water is not needed. Manual shower water flow control is also problematic for many people who are limited in their physical strength, mobility and/or dexterity, such as elderly and disabled individuals who find it challenging to manipulate such manual control hardware. In particular, those who suffer from arthritis often feel extreme pain in manipulating the shower control hardware. Beyond these population segments, there are others who also struggle to work the shower controls, including those recovering from illness or broken limbs, persons who have suffered wounds to their arms or hands, and many other individuals limited in their ability to manipulate the existing shower control hardware. Additionally, specialized motion sensor-based showerheads are unsuitable for most of the individuals noted above due to their own limited range of movement (e.g., sitting on a shower chair if disabled and/or having very limited range of movement, energy, or strength to trigger a motion sensor).

Therefore, what is needed is a way to allow individuals to pause shower water flow when it is not needed as a means of conserving water, as well as away to ease shower control for population segments that have limited ability to work the control hardware of existing showerheads. This includes the elderly, disabled and/or mobility impaired communities, those who suffer from arthritis, and/or anyone who cannot provide sufficient movement to trigger motion sensors integrated into some models of specialized showerheads.

### SUMMARY

To minimize the limitations in the cited references, and to minimize other limitations that will become apparent upon reading and understanding the present specification, the system and method for allowing the control of water flow by voice commands in a residential context, and specifically, within an individual's shower.

One embodiment of the present disclosure may be a voice-controlled smart showerhead. In some embodiments, the voice-controlled smart showerhead may comprise a showerhead housing and an embedded internet switch with built-in wireless connectivity (such as Wi-Fi and/or Bluetooth) configured to connect to a remote electronic device directly or through an intermediary wireless communication protocol, such as being connected to the same wireless network. The remote electronic device may be a smart home device/speaker (such as Amazon Echo or Google Home devices). Preferably, the remote electronic device may comprise a microphone or other audio detection module configured to detect and process sounds. In one embodiment, the remote electronic device may be configured to respond to verbal on/off commands detected by the smart home device. In other embodiments, the remote electronic device may be configured to receive other verbal commands, such as increasing or decreasing water flow, or adjusting water flow. In some embodiments, the embedded internet switch has built-in Wi-Fi connectivity. In some embodiments, the embedded internet switch has built-in Bluetooth connectivity. In this way, the voice-controlled smart showerhead may enable the user to turn water flow on and off using voice commands that are registered and processed by the user's smart home device. In other embodiments, the remote electronic device may be a user's mobile device, such as cell phone or tablet. In other embodiments, the remote electronic device may be substantially any electronic device with a microphone and wireless connectivity.

In one embodiment, the present disclosure may relate to a device is an accessory that fits in between a standard shower arm and a user's existing showerhead, adding voice control functionality to existing shower installations.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps, which are illustrated. When the same numeral appears in different drawings, it refers to the same or like components or steps.

FIG. 1 is an illustration of one embodiment of a water flow regulator.

FIG. 2 is a cross section view of the water flow regulator shown in FIG. 1.

FIG. 3 is an illustration of embodiment of a water flow regulator.

FIG. 4 is another illustration of the water flow regulator shown in FIG. 3.

### DETAILED DESCRIPTION OF THE DRAWINGS

In the following detailed description, numerous specific details are set forth in order to provide a thorough understanding of various aspects of one or more embodiments. However, these embodiments may be practiced without some or all of these specific details. In other instances, well-known methods, procedures, and/or components have not been described in detail so as not to unnecessarily obscure aspects of embodiments.

While multiple embodiments are disclosed, still other embodiments will become apparent to those skilled in the art from the following detailed description. As will be realized, these embodiments are capable of modifications in various obvious aspects, all without departing from the spirit and scope of protection. Accordingly, figures and the detailed descriptions thereof are to be regarded as illustrative in nature and not restrictive. Also, the reference or non-reference to a particular embodiment shall not be interpreted to limit the scope of protection.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about,” may refer to a deviance of between 0.0001-10% from the indicated number or range of numbers.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

As will be appreciated by one skilled in the art, the systems and methods may take the form of an entirely hardware embodiment, an entirely software embodiment, or an embodiment combining software and hardware embodiments. Furthermore, the systems and methods may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, compact discs, read-only-memory (CD-ROMs), optical storage devices, or magnetic storage devices.

Embodiments of the systems and methods are described below with reference to schematic diagrams, block diagrams, and flowchart illustrations of methods, systems, apparatuses and computer program products. It will be understood that each block of the block diagrams, schematic diagrams, and flowchart illustrations, and combinations of blocks in the block diagrams, schematic diagrams, and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner. In some embodiments, computer program instructions may be cloud based or edge based, wherein data related thereto may also be stored in the cloud. In some embodiments, computer program instructions and related data may be stored differently, such that one is stored locally or on a controlled server, whereas the other may be stored in the cloud or edge based systems. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

In the following detailed description of the invention, numerous details, examples, and embodiments of the invention are described. However, it will be clear and apparent to one skilled in the art that the invention is not limited to the embodiments set forth and that the invention can be adapted for any of several applications.

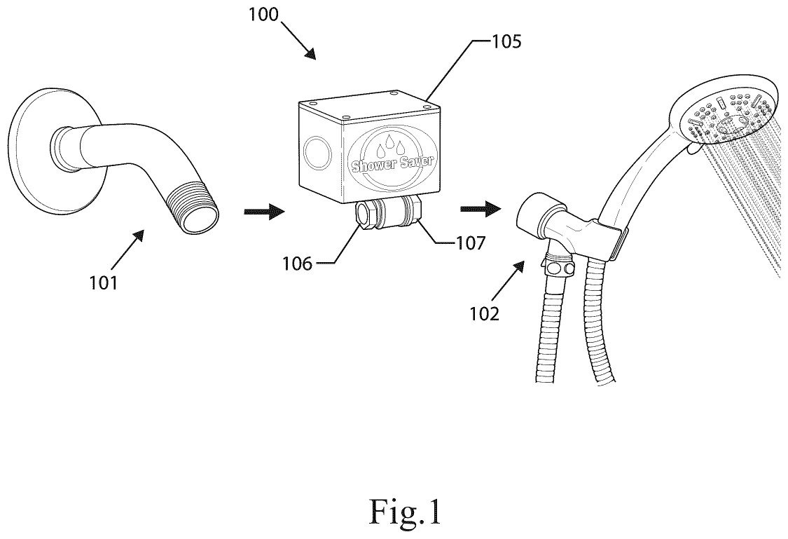

FIG. 1 is an illustration of one embodiment of a water flow regulator. As shown in FIG. 1, the water flow regulator 100 may comprise a housing 105, flow valve 110, mechanical actuator 115, power source 120, electronic controller 125, and communication receiving module 130.

The housing 105 may be the outer shell of the water flow regulator 100 and may be configured to engage a water pipe 101 on a first end 106, and a showerhead 102 on a second end 107. The first and/or second ends 106, 107 may comprise male and/or female threaded fittings, and may comprise swivel connectors. The housing 105 may provide structural support and protection for the internal components of the water flow regulator 100, as well as secure those components. In some embodiments, a housing 105 may be omitted, provided that the remaining components are secured to one another. In a preferred embodiments, female connectors may comprise swivel connectors. In some embodiments, the first and/or second ends 106, 107 may be exterior to the housing 105.

The flow valve 110 may be within the housing 105 and may be responsible for regulating the flow of water through the water flow regulator 100. The flow valve 110 may be adjusted to one or more configurations, including a first configuration (flow configuration), a second configuration (stop configuration), and optionally a third configuration (intermediary configuration). The flow valve 110 may be Flow Control Valves, ball valves, gate valves, globe valves, needle valves, diaphragm valves, solenoid valves, check valves,

The mechanical actuator 115 may be connected to the flow valve 110 and is configured to adjust the flow valve 110 between its various configurations. The mechanical actuator 115 receives activation commands to change the position of the flow valve 110 from the electronic controller 125 and receives energy from the power source 120.

The power source 120 may provide the necessary energy to operate the mechanical actuator 115, the electronic controller 125, and the communication receiving module 130. The power source 120 may be a battery housing configured to receive a battery, or a battery itself. The power source 120 may be a built-in rechargeable battery. In an embodiment where the power source 120 comprises a built-in rechargeable battery, the water flow regulator 100 may also comprise a charging port to facilitate charging.

The electronic controller 125 may be responsible for processing communications received by the communication receiving module 130. Upon processing the communication, the electronic controller 125 transmits activation commands to the mechanical actuator 115 to adjust the flow valve 110. In some embodiments, the electronic controller 125 may be configured to send activation commands configured to cause the mechanical actuator 115 to adjust the flow valve 110 to one of its various configurations.

The communication receiving module 130 is configured to receive various types of communication signals, including audio, WiFi, and/or Bluetooth signals. The received communication is then processed by the electronic controller 125. In some embodiments, the communication receiving module 130 may be a microphone or an electronic wireless communication module. In some embodiments, a user may be able to provide a verbal instruction to their smart home assistant or other remote device, and the instructions may then be communicated to the communication receiving module 130, such that an instruction to Google Home or Siri or Amazon Echo to “turn on the water” turns on water flow through the water flow regulator.

In one embodiment, the water flow regulator 100 may function as follows: the communication receiving module 130 receives a communication signal, which is then processed by the electronic controller 125. Based on the processed communication, the electronic controller 125 sends an activation command to the mechanical actuator 115. The mechanical actuator 115 adjusts the flow valve 110 to the desired configuration, thereby controlling the flow of water through the regulator.

The flow valve 110 may be adjusted to various configurations, comprising a first configuration that allows water to flow through the flow valve 110 at a maximum flow rate, a second configuration that prevents water from flowing through the flow valve 110, or a minimum flow rate, and a third configuration that allows for water flow that is less than the maximum flow rate but more than the minimum flow rate.

In other embodiments, the water flow regulator may be incorporated into, or be part of a showerhead, such that an end user need only affix their newly purchased showerhead to an existing shower arm to install the functionality allowed by the water flow regulator for shower purposes. In this embodiment, the showerhead itself may be analogous to the housing 105.

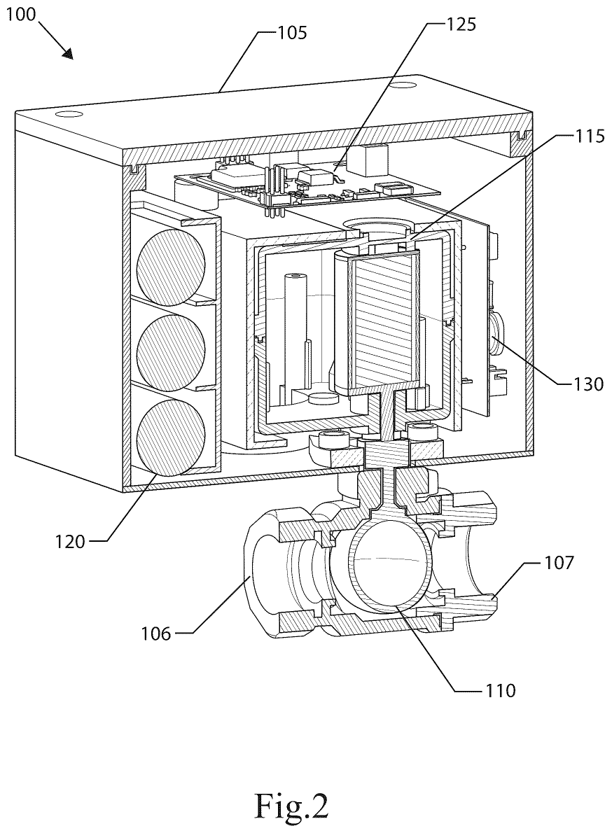

FIG. 2 is a cross section view of the water flow regulator shown in FIG. 1. As shown in FIG. 2, the water flow regulator 100 may comprise the housing 105, flow valve 110, mechanical actuator 115, power source 120, electronic controller 125, and communication receiving module 130.

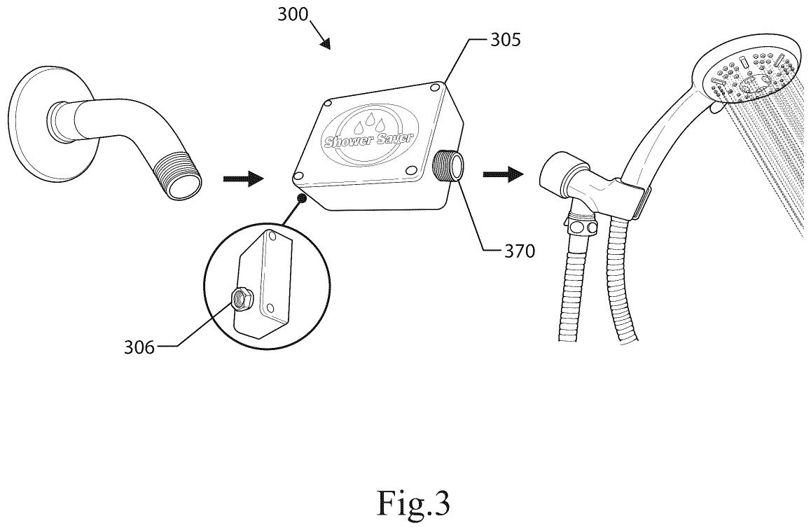

FIG. 3 is an illustration of embodiment of a water flow regulator. As shown in FIG. 2, the water flow regulator 300 may comprise a housing 305, first end 306, and second end 307. The water flow regulator 300 may also comprise a flow valve, mechanical actuator, power source, electronic controller, and communication receiving module that are substantially analogous to their counterparts described hereinabove in FIGS. 1 and 2. In some embodiments, additional adapters may be used, such that if the flow valve includes a plastic based housing, while the first and/or second ends 306, 307 comprise a metal threading,

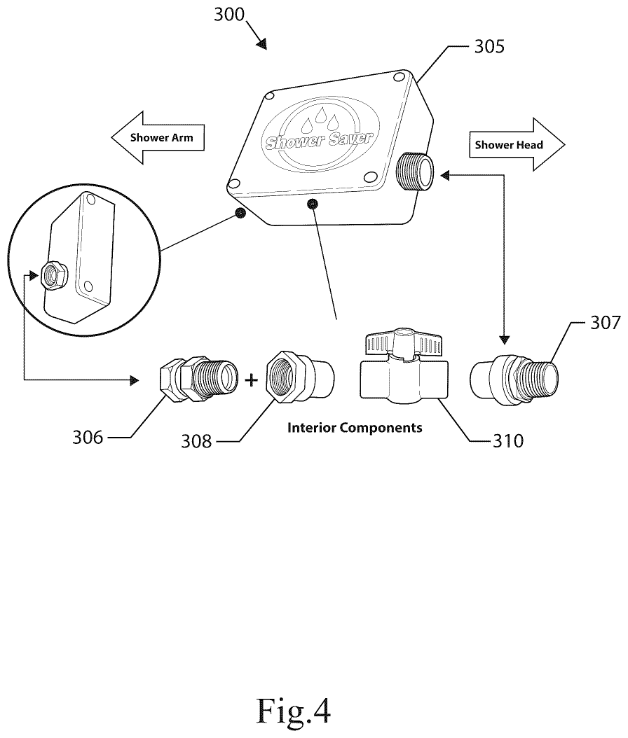

FIG. 4 is another illustration of the water flow regulator shown in FIG. 3. As shown in FIG. 4, the water flow regulator 300 may further comprise an adapter 308 configured to threadably engage the first end 306 and the flow valve 310, wherein the portion of the adapter that engages the first end 306 comprises a metal female threading, while the portion of the adapter that engages the flow valve 310 comprises a plastic male threading. In some embodiments, the second end 307 may engage the flow valve 310 with a plastic male threaded portion, and be configured to engage a shower head with a metal male threaded portion. In other embodiments, the male/female and materials of threading may be adjusted to accommodate for different systems.

Embodiments of the invention described in this specification include a voice-controlled smart showerhead that is configured to turn water flow on and off by voice command. In some embodiments, the voice-controlled smart showerhead comprises a showerhead housing and an embedded internet switch with built-in wireless connectivity (such as Wi-Fi and/or Bluetooth) that is configured to connect to a smart home device/speaker (such as Amazon Echo or Google Home devices) in order to respond to verbal on/off commands registered by the smart home device. In some embodiments, the embedded internet switch has built-in Wi-Fi connectivity. In some embodiments, the embedded internet switch has built-in Bluetooth connectivity. In this way, the voice-controlled smart showerhead enables any user of any ability to turn water flow on and off effortlessly using voice commands that are registered and processed by the user's smart home device.

As stated above, the problem of water waste occurs during everyday showering when people find it difficult or inconvenient to manually turn off water flow during moments in a shower when water is not needed. Manual shower water flow control is also problematic for many people who are limited in their physical strength, mobility and/or dexterity, such as elderly and disabled individuals who find it challenging to manipulate such manual control hardware. In particular, those who suffer from arthritis often feel extreme pain in manipulating the shower control hardware. Beyond these population segments, there are others who also struggle to work the shower controls, including those recovering from illness or broken limbs, persons who have suffered wounds to their arms or hands, and many other individuals limited in their ability to manipulate the existing shower control hardware. Additionally, specialized motion sensor-based showerheads are unsuitable for most of the individuals noted above due to their own limited range of movement (e.g., sitting on a shower chair if disabled and/or having very limited range of movement, energy, or strength). Embodiments of the voice-controlled smart showerhead described in this specification solve such problems by a voice control mechanism that ends up conserving water during a shower simply by pausing water flow when it is not needed, as determined by voice command. Consequently, thousands of gallons of water can be saved each year. In addition, the voice-controlled smart showerhead serves as an inclusive device for individuals with arthritis or limited mobility, reducing the pain and discomfort associated with turning knobs and enhancing the independence of users to ensure they can maintain their personal hygiene with dignity and autonomy.

Embodiments of the voice-controlled smart showerhead described in this specification differ from and improve upon currently existing options. In particular, conventional showerheads with manual on/off switches are inconvenient and not likely to be incorporated into a user's daily routine. They also can be very difficult to operate for those who suffer from arthritis or dexterity problems. Motion sensor equipped showerheads are suitable only for large showers with waterfall showerheads that sense motion directly beneath them which is a small component of showers nationwide. The motion sensor-based showerheads also would not be suitable for individuals with limited ability to sustain continuous movement, whether or not their shower is large. By contrast, the voice-controlled smart showerhead of the present disclosure utilizes voice technology and can be used in shower setting as long as a companion smart home device is available. In this way, the voice-controlled smart showerhead is different from anything that exists in the market because of its innovative voice-controlled technology, making it the only showerhead in the market that allows users to effortlessly pause water flow during non-essential showering activities.

The voice-controlled smart showerhead of the present disclosure may be comprised of the following elements. This list of possible constituent elements is intended to be exemplary only and it is not intended that this list be used to limit the voice-controlled smart showerhead of the present application to just these elements. Persons having ordinary skill in the art relevant to the present disclosure may understand there to be equivalent elements that may be substituted within the present disclosure without changing the essential function or operation of the voice-controlled smart showerhead.
1. Showerhead housing
2. Battery compartment
3. Internal internet/Wi-Fi switch controlling water flow

The various elements of the voice-controlled smart showerhead of the present disclosure may be related in the following exemplary fashion. It is not intended to limit the scope or nature of the relationships between the various elements and the following examples are presented as illustrative examples only. The voice-controlled smart showerhead is made with a showerhead housing that conforms approximately to a traditional showerhead. Embedded in the showerhead housing is a battery compartment and an internal internet/Wi-Fi switch. A user's existing smart home device/speaker (such as Amazon Echo or Google Home devices) captures and analyzes the audible vocalizations of the person in the shower to determine when the person is issuing a control command. The smart home device/speaker is wirelessly connected to the showerhead's internet/Wi-Fi switch, triggering the switch to move to the on or off position based on the corresponding voice command issued by the user.

The voice-controlled smart showerhead of the present disclosure generally works by the internet/Wi-Fi switch within the voice-controlled smart showerhead connecting wirelessly to the nearby smart home device. The smart home device can be any voice-activated system, such as Amazon Echo or Google Home device, which captures, analyzes and relays voice commands to the voice-controlled smart showerhead to trigger the internet/Wi-Fi switch to turn to the on or off position.

To make the voice-controlled smart showerhead of the present disclosure, a manufacturer may produce the showerhead housing in any form that can incorporate a battery compartment and can embed an internal internet/Wi-Fi switch that is completely self-contained within the device. Thus, the showerhead housing should be designed to be waterproof to protect the internal electronic components. On the other hand, the size and proportions of the voice-controlled smart showerhead can be based on the design, so long as the showerhead housing is capable of accommodating the battery compartment and the internet/Wi-Fi switch.

To use the voice-controlled smart showerhead of the present disclosure, one may install/deploy the showerhead on any standard shower arm. Users will be able to conserve water by pausing the water flow during non-essential water usage moments, such as lathering or washing hair. Pausing water flow in this way can save a household thousands of gallons of water each year. As an assistive technology, the voice-controlled smart showerhead empowers those with arthritis and mobility impairment with the ability to initiate and end a shower without relying on assistance from others. This feature significantly reduces pain and discomfort associated with turning knobs, enhancing a person's ability to independently manage their showers. Once a preferred temperature mix is established, the voice-controlled smart showerhead will ensure that future showers can be taken by way of a touchless experience with no need to recalibrate.

Unless otherwise stated, all measurements, values, ratings, positions, magnitudes, sizes, locations, and other specifications, which set forth in this specification, including in the claims that follow, are approximate, not exact. They are intended to have a reasonable range, which is consistent with the functions to which they relate and with what is customary in the art to which they pertain.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The foregoing description of the preferred embodiment has been presented for the purposes of illustration and description. While multiple embodiments are disclosed, still other embodiments will become apparent to those skilled in the art from the above detailed description, which shows and describes the illustrative embodiments. As will be realized, these embodiments are capable of modifications in various obvious aspects, all without departing from the spirit and scope of the present disclosure. Accordingly, the detailed description is to be regarded as illustrative in nature and not restrictive. Also, although not explicitly recited, one or more additional embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

I claim:

1. A water flow regulator comprising:
a housing;
a flow valve;
a mechanical actuator;
a power source;
a communication receiving module; and
an electronic controller;
wherein said flow valve comprises one or more configurations;
wherein said mechanical actuator is configured to adjust said flow valve between said one or more configurations;
wherein said communication receiving module is configured to receive a communication;
wherein said microcontroller is configured to process said communication and transmit an activation command to said mechanical actuator; and
wherein said power source is configured to provide an energy to said mechanical actuator, said electronic controller, and said wireless communication module.

2. The water flow regulator of claim 1, wherein said one or more configurations comprise a first configuration and a second configuration.

3. The water flow regulator of claim 2, wherein said first configuration is a flow configuration and said second configuration is a stop configuration;
wherein said flow configuration allows water to flow through said flow valve; and
wherein said stop configuration does not allow water to flow through said flow valve.

4. The water flow regulator of claim 3, wherein said housing is configured to engage a water pipe.

5. The water flow regulator of claim 3, wherein said housing is configured to engage a showerhead.

6. The water flow regulator of claim 3, wherein said one or more configurations comprises a third configuration.

7. The water flow regulator of claim 6, wherein said third configuration is an intermediary configuration; and
wherein said intermediary configuration allows for water flow that is less than a maximum water flow rate and more than a minimum flow rate.

8. The water flow regulator of claim 1, wherein said communication receiving module is configured to receive an audio.

9. The water flow regulator of claim 8, wherein said communication receiving module is configured to receive a WiFi signal.

10. The water flow regulator of claim 9, wherein said communication receiving module is configured to receive a Bluetooth signal.

11. A smart showerhead, comprising:
a housing;
a flow valve;
a mechanical actuator;
a power source;
a wireless communication module; and
an electronic controller;
wherein said flow valve comprises one or more configurations;
wherein said mechanical actuator is configured to adjust said flow valve between said one or more configurations;
wherein said wireless communication module is configured to receive a communication;
wherein said microcontroller is configured to process said communication and transmit an activation command to said mechanical actuator; and
wherein said power source is configured to provide an energy to said mechanical actuator, said electronic controller, and said wireless communication module.

12. The smart showerhead of claim 11, wherein said one or more configurations comprise a first configuration and a second configuration.

13. The smart showerhead of claim 12, wherein said first configuration is a flow configuration and said second configuration is a stop configuration;
wherein said flow configuration allows water to flow through said flow valve; and
wherein said stop configuration does not allow water to flow through said flow valve.

14. The smart showerhead of claim 13, wherein said one or more configurations comprises a third configuration;
wherein said third configuration is an intermediary configuration;
wherein said intermediary configuration allows for water flow that is less than a maximum water flow rate and more than a minimum flow rate.

15. The smart showerhead of claim 13, wherein said wireless communication module is configured to receive wireless electronic signals.

16. The smart showerhead of claim 13, wherein said wireless communication module is configured to receive Wi-Fi signals.

17. The smart showerhead of claim 13, wherein said wireless communication module is configured to receive Bluetooth signals.
